(19) United States
(12) Patent Application Publication
(10) Pub. No.: US 2015/0349555 A1
(43) Pub. Date: Dec. 3, 2015

(54) Retractable Charging Device

(71) Applicant: Alfredo Ortiz Baeza, West Palm Beach, FL (US)

(72) Inventor: Alfredo Ortiz Baeza, West Palm Beach, FL (US)

(21) Appl. No.: 14/712,461

(22) Filed: May 14, 2015

Related U.S. Application Data
(60) Provisional application No. 62/003,875, filed on May 28, 2014.

(51) Int. Cl. H02J 7/00

(52) U.S. Cl. CPC H02J 7/0044

(57) ABSTRACT

A retractable charging device for charging mobile electronic devices and the like. The retractable charging device includes a housing having a spool therein, on which an elongated charging cable is wound. The charging cable extends outward from the housing through an aperture thereon. The end of the charging cable includes an input adapter for insertion into a mobile electronic device, such as a smartphone, tablet, or the like. The spool is spring-biased so that the charging cable can be wound on the spool and fully stored within the housing. The cable can be extended from the housing for use in charging a mobile electronic device. Further, the housing includes an electrical plug thereon for connection to an electrical outlet. The electrical plug is rotatable and includes prongs that can pivot outward from the housing for use or that can be folded for storage.

### CROSS REFERENCE TO RELATED APPLICATION

This application claims the benefit of U.S. Provisional Application No. 62/003,875 filed on May 28, 2014. The above identified patent application is herein incorporated by reference in its entirety to provide continuity of disclosure.

### BACKGROUND OF THE INVENTION

1. Field of the Invention

The present invention relates to charging cables for mobile electronic devices. More specifically, the present invention provides a retractable charging device comprising a housing in which a cable is wound around a spool and can be extended therefrom as desired by a user. In this way, the cable can be wound around the spool for storage, and extended therefrom for use. The housing includes a rotatable electrical plug that can be engaged with an electrical outlet so as to provide electricity to the charging cable.

People frequently use various electronic devices throughout the course of the day such as tablets, laptops, smartphones, and various other similar devices. These devices are often unable to remain fully charged throughout the day, requiring the user to periodically charge his or her device in order to continue using the same. As a result, the user must carry a charging cable in a purse or bag in order to charge the device when required.

Carrying a charging cable can be inconvenient as the cable is difficult to wind or store in a compact configuration. Thus, the charging cable may consume considerable space within a bag or purse, and the cable can become easily tangled. It can be time consuming and frustrating to untangle the cable, and pulling on a tangled cable may cause damage thereto. Similarly, storing a cable haphazardly in a bag with various other items can cause the cable to bend, fray, or otherwise become damaged. This may diminish the performance or appearance of the charging cable, requiring replacement of the cable.

2. Description of the Prior Art

Devices have been disclosed in the prior art that relate to charging devices for mobile electronic devices. These include devices that have been patented and published in patent application publications. These devices generally relate to charging devices having retractable cables. The following is a list of devices deemed most relevant to the present disclosure, which are herein described for the purposes of highlighting and differentiating the unique aspects of the present invention, and further highlighting the drawbacks existing in the prior art.

Devices in the prior art provide electrical plugs that are retractable or that include retractable cables, such as U.S. Published Patent Application Number 2002/0187675, U.S. Published Patent Application Number 2013/0257376, U.S. Published Patent Application Number 2012/0319487, and U.S. Published Patent Application Number 2013/0328526. Other devices relate to charging devices having illumination sources thereon, such as U.S. Published Patent Application Number 2005/0093511.

These prior art devices have several known drawbacks. The devices in the prior art fail to disclose a compact device adapted to charge a mobile electronic device, wherein the device houses a retractable charging cable that can be easily deployed and wound. Further, such devices fail to disclose a rotating electrical plug having prongs that can be pivoted outward from the housing for use, and folded into the housing for storage.

In light of the devices disclosed in the prior art, it is submitted that the present invention substantially diverges in design elements from the prior art and consequently it is clear that there is a need in the art for an improvement to existing retractable charging devices. In this regard the instant invention substantially fulfills these needs.

### SUMMARY OF THE INVENTION

In view of the foregoing disadvantages inherent in the known types of retractable charging devices now present in the prior art, the present invention provides a new retractable charging device wherein the same can be utilized for providing convenience for the user when transporting a mobile device charger in a compact configuration.

It is therefore an object of the present invention to provide a new and improved retractable charging device that has all of the advantages of the prior art and none of the disadvantages.

It is another object of the present invention to provide a retractable charging device having an elongated cable with an input adapter for connection to a mobile device in order to charge the same.

A further object of the present invention is to provide a retractable charging device having a recessed area adapted to receive the input adapter for storage thereof.

Another object of the present invention is to provide a retractable charging device wherein an elongated charging cable is wound on a spring-biased spool that allows the charging cable to be easily retracted when not in use.

A further object of the present invention is to provide a retractable charging device having a housing with a pivotally rotatable electrical plug.

Yet another object of the present invention is to provide a retractable charging device having an electrical plug with folding prongs that can be extended for use and rotated into a stored configuration when not in use.

Another object of the present invention is to provide a retractable charging device for use with various types of mobile electronic devices, such as laptops, smartphones, and tablets, among others.

Yet another object of the present invention is to provide a retractable charging device having one or more indicator lights thereon for providing illumination.

An additional object of the present invention is to provide a retractable charging device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the retractable charging device of the present invention.

FIG. 2 shows a cross sectional view of the housing of the present invention.

FIG. 3A shows a perspective view of the rotatable electrical plug of the present invention in a first position.

FIG. 3B shows a perspective view of the rotatable electrical plug of the present invention in a second position.

### DETAILED DESCRIPTION OF THE INVENTION

Reference is made herein to the attached drawings. Like reference numerals are used throughout the drawings to depict like or similar elements of the retractable charging device. For the purposes of presenting a brief and clear description of the present invention, the preferred embodiment will be discussed as used for providing a user with an easily transportable charging device that can be stored in a compact configuration. The figures are intended for representative purposes only and should not be considered to be limiting in any respect.

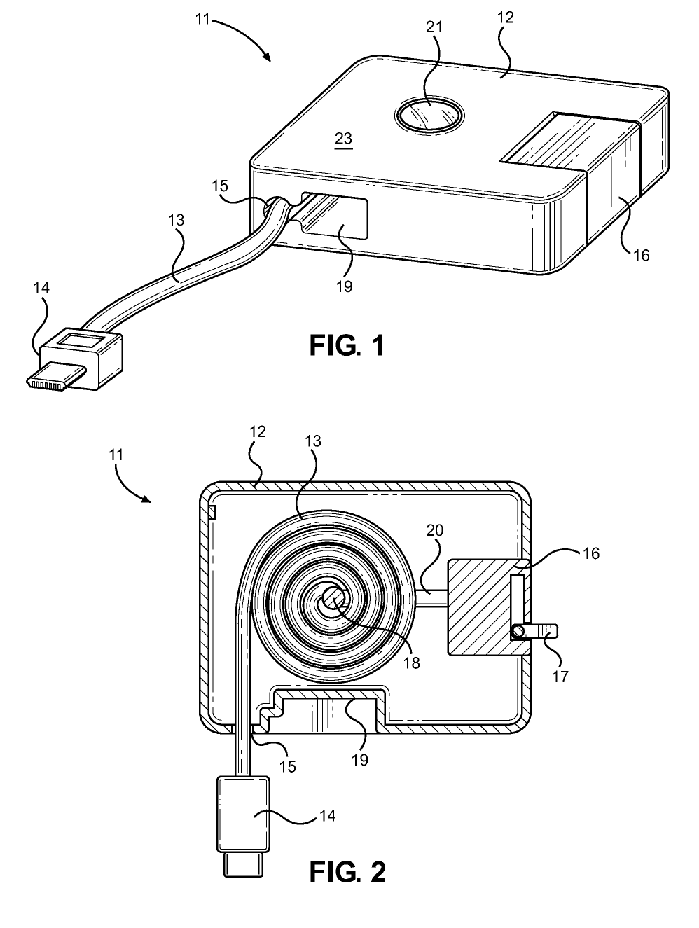

Referring now to FIG. 1, there is shown a perspective view of an embodiment of the retractable charging device of the present invention. The retractable charging device 11 comprises a housing 12 having an interior volume in which a charging cable 13 having a first end and a second end is stored. The charging cable 13 includes an elongated, flexible cable having a first end secured to a spool within the housing, and electrically connected to an electrical plug disposed on the housing. The second end of the charging cable 13 includes an adapter 14 for connection to a mobile electronic device, such as a smartphone, tablet, laptop, and the like. The charging cable 13 is wound around a spool disposed in the housing 12 so that the charging cable 13 can be stored in a compact configuration within the housing 12. Alternatively, the charging cable 13 can be extended from the housing 12 through an aperture 15 thereon for use. The housing 12 includes a recessed area 19 adapted to receive the adapter 14 when it is not in use. The recessed area 19 is sized so as to receive the adapter 14 and to securely hold the same therein. When stored in the recessed area 19, the adapter 14 does not extend outward from the housing 12 such that it is discretely stored. The housing 12 is preferably compact and has a substantially rectangular configuration. However, in other embodiments, the housing 12 may have alternate configurations.

The front surface 23 of the housing 12 includes one or more indicator lights 21 thereon. The indicator light 21 provides illumination when the device 11 is connected to an electrical power source via the electrical plug 16 disposed on the housing 12. Thus, the indicator light 21 is electrically connected to the charging cable 13 and includes the necessary circuitry adapted to cause the indicator light 21 to illuminate when the charging device 11 is connected to a power source.

The spool on which the charging cable is wound is preferably spring biased so that the charging cable 13 is biased toward a wound position for storage. The user can grasp the adapter 14 on the second end of the charging cable 13 and can pull the adapter 14 in order to draw the charging cable 13 outward from the housing 12. Once the charging cable 13 has been extended to the desired extent, the spool automatically locks the charging cable 13 at the desired length, preventing the charging cable 13 from retracting into the housing 12. The user can extend the charging cable 13 from the housing 12 and slowly release the same in order to allow the cable 13 to be wound on the spool within the housing 12.

Referring now to FIG. 2, there is shown a cross sectional view of the housing of the present invention. The housing 12 comprises a hollow interior volume in order to provide space for the storage of the charging cable 13. Further, the interior volume includes the necessary circuitry for electrically connecting the indicator light to the charging cable. A spool 18 is positioned inside of the housing 12 and is adapted to have the charging cable 13 wound thereon. The spool 18 is preferably spring-biased so that the cable 13 is automatically wound thereon. A first end 24 of the cable 13 is electrically connected to the electrical plug 16 on the housing 12 via a connecting cable 20. In this way, when the prongs 17 of the electrical plug 16 are engaged with a power source, such as a wall outlet, the device 11 can receive power. The second end 25 of the cable 13 extends outward from an opening 15 on the housing 12 and includes an adapter 14 thereon. The adapter 14 is sized so that it is unable to pass through the opening 15, preventing the adapter 14 from being withdrawn into the housing 12 where it would be difficult to retrieve.

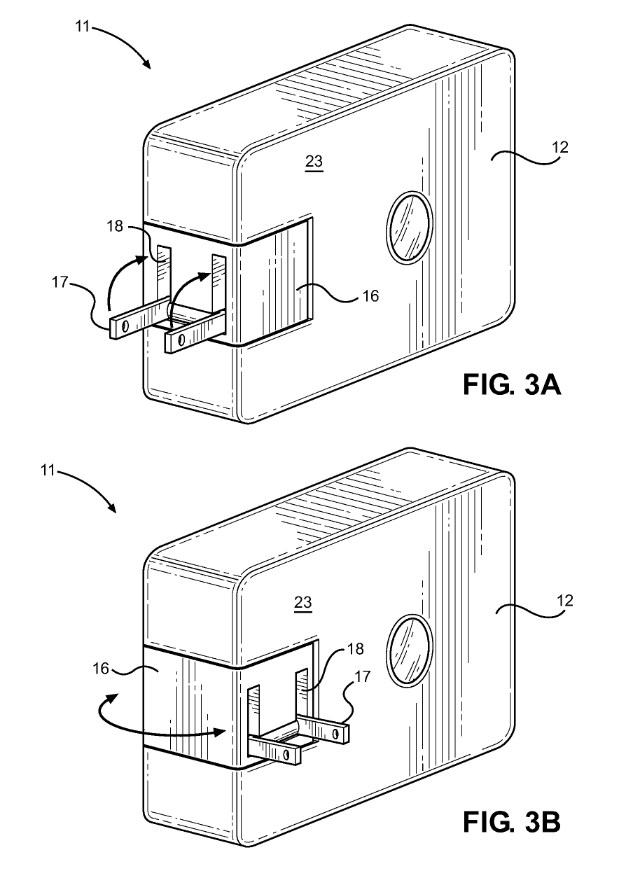

Referring now to FIGS. 3A and 3B, there are shown close-up views of the rotatable electrical plug of the present invention. An electrical plug 16 is positioned on an edge of the housing 12 so that it is exposed on the front surface 23, rear surface, and a side of the housing 12. The electrical plug 16 is rotatably positioned on the housing 12 so that it can rotate in a single plane. In this way, the prongs 17 of the electrical plug 16 can be oriented so as to extend outward from the front surface 23, the side of the housing 12, or the rear surface thereof. This provides the user with flexibility in how to position the housing 12 while connected to an electrical outlet.

Further, the prongs 17 are pivotally connected to the electrical plug 16 and can be folded into a recess 18 in the electrical plug 16 for storage, or can be folded outward therefrom for use. Thus, the prongs 17 are adapted to rotate ninety degrees. In an extended configuration, the prongs 17 are arranged perpendicularly to the housing 12 so that the prongs 17 can be inserted into an outlet. In a stored configuration, the prongs 17 are rotated ninety degrees so that they are enclosed within the recess 18 and do not extend outward from the housing 12. In this way, the housing 12 can maintain a compact profile, and the electrical plug 16 does not extend outward therefrom, which helps to prevent the electrical plug 16 from catching on other items and from being damaged.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A retractable charging device, comprising:
a housing having an interior volume in which a spool is positioned;
an elongated charging cable having a first end and a second end, wherein said elongated charging cable is wound on said spool;
said first end electrically connected to an electrical plug attached to said housing;
said second end having an adapter thereon for connection to a mobile electronic device.

2) The retractable charging device of claim 1, wherein said spool is spring biased such that said elongated charging cable is wound on said spool in a stored configuration.

3) The retractable charging device of claim 1, wherein said housing further includes an indicator light thereon adapted to illuminate when said housing is connected to a power source.

4) The retractable charging device of claim 1, wherein said electrical plug is rotatably mounted to said housing, such that said electrical plug can be oriented towards a front surface of said housing or a rear surface of said housing.

5) The retractable charging device of claim 4, wherein said electrical plug includes a pair of prongs that are pivotally connected thereto.

6) The retractable charging device of claim 5, wherein said electrical plug further comprises a recess adapted to receive said pair of prongs when said pair of prongs is folded into a stored configuration.

7) The retractable charging device of claim 1, wherein said housing further comprises a recessed area adapted to receive said adapter on said cable therein when said adapter is not in use, and when said cable is retracted.
